(19) United States
(12) Patent Application Publication
(10) Pub. No.: US 2015/0043034 A1
(43) Pub. Date: Feb. 12, 2015

(54) PRINTING CONTROL DEVICE, PRINTING CONTROL METHOD, AND PRINTING CONTROL PROGRAM

(71) Applicant: SEIKO EPSON CORPORATION, Tokyo (JP)

(72) Inventor: Satoshi YAMAZAKI, Matsumoto (JP)

(21) Appl. No.: 14/451,629

(22) Filed: Aug. 5, 2014

(30) Foreign Application Priority Data
Aug. 6, 2013 (JP) 2013-163045

(51) Int. Cl. G06K 15/02

(52) U.S. Cl. CPC G06K 15/1836
USPC 358/1.15

(57) ABSTRACT

A printing control device includes an image fetching unit configured to fetch image files expressing a page containing objects, a decision unit configured to divide the page into a plurality of bands, and configured to, for each band, decide whether or not to expand to a band unit raster format image data based on features of the objects contained in the band, an image expansion unit configured to expand to the image data according to drawing command for drawing the objects contained in the band, and a transfer unit configured to, for a band that has been expanded to the image data, transfer the expanded band unit image data to a printing unit, and, for a band that has not been expanded to the image data, transfer drawing command for drawing the objects contained in the band to the printing unit.

### CROSS-REFERENCE TO RELATED APPLICATIONS

This application claims priority to Japanese Patent Application No. 2013-163045 filed on Aug. 6, 2013. The entire disclosure of Japanese Patent Application No. 2013-163045 is hereby incorporated herein by reference.

### BACKGROUND

1. Technical Field

The present invention relates to a printing control device, a printing control method, and a printing control program.

2. Related Art

There is a demand for so-called high speed printing that executes a larger volume of printing in a shorter time using a printer.

Here, printing information processing devices are known for which one page is divided equally and made into virtual bands, printing information such as text, graphics or the like that exist within the virtual band is analyzed and an intermediate code is created, in that process, a decision is made of whether or not compression is required according to a designated standard, and when compression is required, expansion is done to a bit image, and compression is done to create compressed bit image data, and on the other hand, when compression is not required, the intermediate code is saved as is in RAM, and after that, based on the intermediate code existing for each virtual band, in the case of compressed bit image data, expansion is performed to make a bit image, and when that is not the case, data managed by the intermediate code is expanded and made to a bit image, and these bit images are transferred to a printing device (see JP-A-H06-171160 (Patent Document 1), for example).

### SUMMARY

One important element for realizing high speed printing is the shortening of the time required when transferring the information required for having a printer print an image (transfer time) to the printer. From this perspective, a constitution is used that, by transferring from the host computer side to the printer printing instructions for the printer that are described using page description language (PDL) that can be interpreted by the printer, is able to reduce the volume of information that is transferred, and thus contributes to shortening of the transfer time. However, Patent Document 1 noted above is an item that always transfers to the printing device bit image data after expansion, so this was insufficient in terms of realizing high speed printing by shortening the transfer time.

Another important element for realizing high speed printing is the reduction of the volume of processing to be executed on the printer side at which transfer of the information necessary for printing is received. Therefore, technology that contributes to the realization of high speed printing by reducing the processing burden on the transfer receiving side while also shortening the transfer time is truly needed.

The present invention was created to address at least the problems noted above, and by effectively incorporating the measures for reducing the processing burden on the transfer receiving side, provided is a printing control device, a printing control method, and a printing control program capable of realizing speed printing more precisely.

One aspect of the present invention is a printing control device that is equipped with an image fetching unit for fetching image files expressing a page containing objects, a decision unit for dividing the page into a plurality of bands, and for each band, deciding whether or not to expand to band unit raster format image data based on features of the objects contained in the band, an image expansion unit, that, for a band for which it is decided to expand to the band unit raster format image data, expands to the band unit raster format image data according to drawing command for drawing the objects contained in the band, and a transfer unit that, for a band that has been expanded to the band unit raster format image data, transfers the expanded band unit image data to a printing unit, and for a band that has not been expanded to the band unit raster format image data, transfers drawing command for drawing the objects contained in the band to the printing unit.

Here, an “object” is a subject or object expressed within a page to be printed, and in specific terms, means areas that are respectively expressed having a certain level of consolidation, such as a photograph, letters (sentences), graphics, or the like.

With the constitution of the present invention, image data is expanded to band unit raster format only for a band for which it has been decided to expand to band unit raster format image data based on the features of the objects contained in the band, and that image data is transferred to a printing unit, and for a band other than this, drawing command for drawing the objects contained in the band are transferred to the printing unit. In other words, when expanding to raster format image data on the printing unit side which received transfer of the drawing command, it is possible to expand to raster format image data before transfer only for a band for which the processing burden is anticipated to be of a certain size. As a result, it is possible to effectively reduce the processing burden on the printing unit side while also reducing the transfer volume to the printing unit (shorten the transfer time) by transferring the drawing command.

The decision criteria for the decision unit covers a wide range.

As an example, the decision unit, at least when the objects contained in the band subject to decision are expressed as raster format image data and are more than a first reference value, can decide to expand the band subject to decision to the band unit raster format image data.

With this constitution, in a state for which the processing burden is expected to be large when expanding to raster format image data corresponding to the entire band because there is a large amount of raster format image data (objects) within the band, it is possible to not have such a burden placed on the printing unit.

As another example, the decision unit, at least when the drawing command for drawing the objects contained in the band subject to decision is more than a second reference value, can decide to expand the band subject to decision to the band unit raster format image data.

With this constitution, in a state for which the processing burden is expected to be large when expanding to raster format image data corresponding to the entire band because there are many drawing commands for drawing the objects within the band, it is possible to not have such a burden placed on the printing unit.

As another example, the decision unit, at least when the number of times of logical operation according to a binary operation set with the drawing command for drawing the objects contained in the band subject to decision is greater than a third reference value, can decide to expand the band subject to decision to the band unit raster format image data.

With this constitution, in a state for which the processing burden is expected to be large when expanding to raster format image data corresponding to the entire band because there is a large number of times of the logical operation according to a binary operation set with the drawing command for drawing the objects within the band, it is possible to not have such a burden placed on the printing unit.

The technical idea of the present invention can be realized not only in the aspect of a printing control device, but can also be materialized using other items. This can also be understood as an invention of a method (printing control method) equipped with steps corresponding to the features of the printing control device of any of the aspects described above, an invention of a printing control program for which that method is executed on designated hardware (computer), or an invention of a computer-readable recording medium on which that program is recorded. Also, the printing control device can be realized as a standalone device, and can be realized as a combination of a plurality of devices. Furthermore, when realizing the printing control device as a combination of a plurality of devices, it is possible to understand the invention as a system constituted by that plurality of devices, or a method correlating to that system.

### BRIEF DESCRIPTION OF THE DRAWINGS

Referring now to the attached drawings which form a part of this original disclosure:

FIG. 1 is a drawing that schematically shows the hardware configuration and software configuration;

FIG. 2 is a flow chart showing the process executed on the first device side with the first embodiment;

FIG. 3 is a drawing typically showing an example of a specified file;

FIG. 4 is a drawing showing an example of each object contained in one band;

FIG. 5 is a drawing for describing the rendering for one band;

FIG. 6 is a flow chart showing the process executed on the second device side;

FIG. 7 is a flow chart showing the process executed on the first device side with the second embodiment;

FIG. 8 is a drawing for describing the number of drawing commands for an object;

FIG. 9 is a flow chart showing the process executed on the first device side with the third embodiment; and

FIG. 10 is a drawing showing an example of the state when the object is drawn using a binary operation.

### DETAILED DESCRIPTION OF EXEMPLARY EMBODIMENTS

Hereafter, we will describe modes of carrying out the invention while referring to the drawings.

1. Device Overview

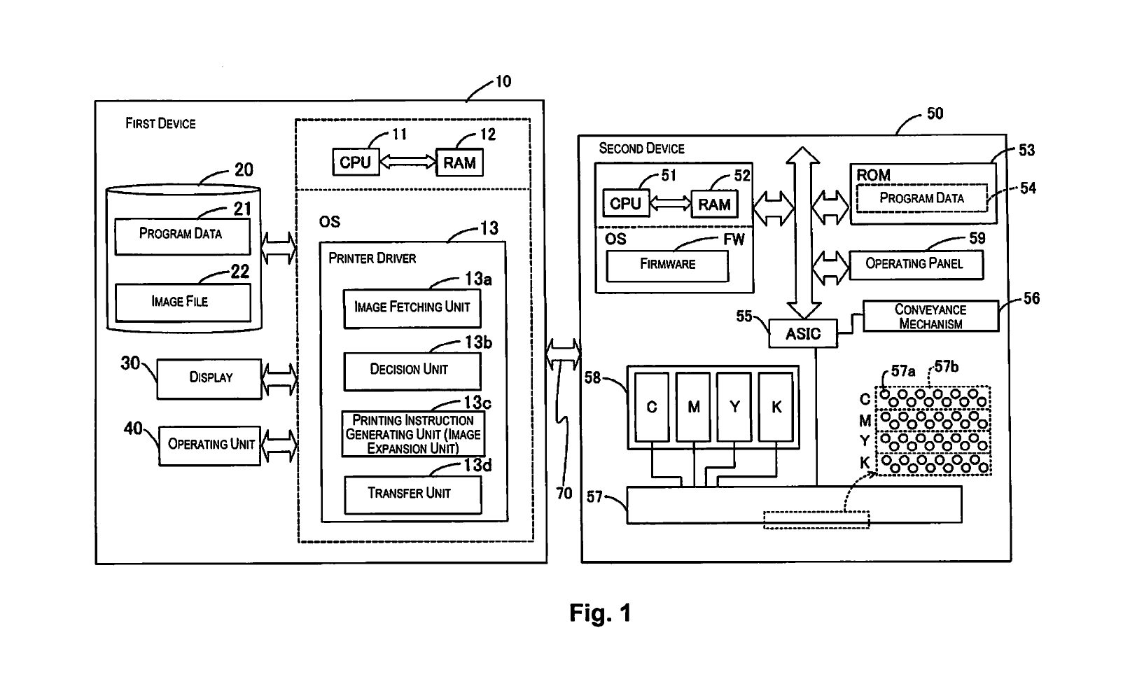

FIG. 1 schematically shows the hardware configuration and software configuration of this embodiment. FIG. 1 shows a first device 10 and a second device 50. The first device 10 has a function of controlling the second device 50 and having printing executed by the second device 50, and applicable items include, for example, a personal computer (PC), a server, a mobile terminal device or the like. The second device 50 is a printer. A printer is an output device for creating a hard copy recording of data with a main pattern of rows of discrete graphic characters belonging to one or a plurality of character sets set in advance (JIS X0012-1990). In many cases, the printer can also be used as a plotter. A plotter is an output device that directly creates a hard copy recording of data using a two dimensional graphic mode on a removable medium (JIS X0012-1990). The second device 50 can be an item that can function as a printer, and can also be a so-called combined machine that also functions as a scanner or copy machine.

The first device 10 is applicable as an example of the printing control device. Alternatively, a system 100 consisting of the first device 10 and the second device 50 can be regarded as the printing control device, and it is also possible to regard only the second device 50 as the printing control device. All or at least a portion of the second device 50 is applicable as the printing unit. Also, the first device 10 and the second device 50 are not required to be respectively individual devices. Also included in this embodiment are constitutions whereby the first device 10 and the second device 50 can be applied as each unit within one product constituted as an integrated unit, or whereby a portion of the concerned product functions as the first device 10, and the other part functions as the second device 50.

With the first device 10, a CPU 11 controls the second device 50 by expanding program data 21 stored in a hard disk drive (I-IDD) 20 or the like in memory such as a RAM 12 or the like and performing operations according to the program data 21 under an OS. The program data 21 can also be said to be a printer driver 13 for controlling the second device 50. The printer driver 13 is a program for executing on the CPU 11 each function including of an image fetching unit 13a, a decision unit 13b, a printing instruction generating unit 13c, a transfer unit 13d and the like. We will describe each of these functions later. The printing instruction generating unit 13c also serves as an image expansion unit.

A display 30 is connected as a display unit to the first device 10, and user interface (UI) screens needed for various processes are displayed on the display 30. The first device 10 is also equipped as appropriate with an operating unit 40 realized using a keyboard, mouse, various buttons, a touch pad, touch panel or the like, for example, and the instructions necessary for each process are input by the user via the operating unit 40. The first device 10 is connected to be able to communicate with the second device 50 via a transfer path 70. The transfer path 70 is generally named a communication path that is either wired or wireless. When the first device 10 and the second device 50 are an integrated unit product as described above, the transfer path 70 is a communication path within that product. As described later, with the first device 10, using the printer driver 13 function, band unit printing instructions are sent to the second device 50 via the transfer path 70. The contents of the band unit printing instructions are described later.

With the second device 50, a CPU 51 expands program data 54 stored in a ROM 53 or the like in memory such as a RAM 52, and by performing an operation according to the program data 54 under an OS, controls itself. The program data 54 can also be called firmware FW for controlling the second device 50. The firmware FW executes as appropriate decompression of compressed data, command interpretation or the like based on the printing instructions sent from the first device 10, and generates printing data. Then, by that printing data being sent to an ASIC 55, it is possible to have printing executed based on the printing data.

The ASIC 55 fetches the printing data, and based on the printing data, drive signals are generated for driving a conveyance mechanism 56, a printing head 57 or the like, for example. The printing head 57 correlates to a permanent head, and generates ink drops continuously or intermittently. It is a mechanical unit or electrical unit of the printer main unit (JIS Z8123-1: 2013). The second device 50 has a cartridge 58 mounted for each of a plurality of ink types. With the example of FIG. 1, cartridges 58 corresponding to each type of liquid including cyan (C), magenta (M), yellow (Y), and black (K) are mounted. However, the specific number of types of ink used by the second device 50 is not limited to that described above, and for example it is possible to use various inks, such as light cyan, light magenta, orange, green, gray, light gray, white, metallic and the like. Also, the second device 50 is equipped with the printing head 57 that sprays (jets) ink supplied from each cartridge 58 from a large number of nozzles 57a. Therefore, the second device 50 correlates to an inkjet printer. An inkjet printer is a non-impact type printing device, and is an item by which characters are formed on paper by spraying of ink particles or droplets (JIS X0012-1990).

The printing head 57 of this embodiment is a line type printing head in an elongated shape. The printing head 57 is fixed at a designated position inside the second device 50, for example. With the printing head 57, the direction that intersects the direction in which the printing substrate moves (the conveyance direction) is the lengthwise direction, and a nozzle row is equipped for which a plurality of nozzles 57a are linked in the lengthwise direction. That lengthwise direction can be expressed as the nozzle row direction. “Intersecting” here means orthogonal. However, orthogonal as stated with this specification means not only strictly a right angle (90 degrees), but also includes a certain level of angle tolerance allowed in terms of product quality. The nozzle row has a length corresponding to at least the width for which it is possible to print on the printing substrate of the width of the printing substrate in the lengthwise direction. Also, the nozzle row is provided for each ink type used by the second device 50. FIG. 1 shows an example of a portion of each nozzle row for each of CMYK on a nozzle opening surface 57b (the surface formed by the opening of the nozzle 57a) of the printing head 57 within the range enclosed by the dot-dash line. Each nozzle row for each of CMYK is aligned along the conveyance direction. Each nozzle row of each of CMYK can be constituted by only one row of nozzle rows for which the nozzles 57a are aligned along the lengthwise direction, or as shown by example in FIG. 1, can also be constituted by a plurality of nozzle rows in parallel and skewed by a designated pitch along the lengthwise direction (constituted in a so-called zigzag form).

Inside the printing head 57, piezo electric elements for having ink (ink drops) sprayed from the nozzles 57a are provided corresponding to each nozzle 57a. The piezo electric elements deform when the drive signals are applied, and make ink spray from the corresponding nozzles 57a. A conveyance mechanism 56 is equipped with a paper feeding motor or paper feeding roller (not illustrated), and by undergoing drive control by the ASIC 55, the printing substrate is conveyed along the conveyance direction. The printing substrate is a material for holding a printed image. A rectangular item is typical as the shape, but there are also circles (e.g. optical disks such as a CD-ROM, DVD or the like), triangles, squares, polygons and the like, and at the least, this includes all of the paper and cardboard product types and processed products noted in Japanese Industrial Standard “JIS P0001: 1998, Paper, Cardboard and Pulp Terminology.”

The second device 50 is further equipped with an operating panel 59. The operating panel 59 includes a display unit (e.g. a liquid crystal panel), a touch panel formed inside the display unit, and various buttons and keys, receives input from the user, and displays the necessary UI screens on the display unit.

The second device 50 is not limited to being a line printer equipped with a line type printing head as noted above. For example, the second device 50 can also be a so-called serial printer for which the printing head 57 is mounted in a carriage that moves along a direction intersecting the conveyance direction (main scan direction). The means for spraying ink from the nozzle is also not limited to piezo electric elements, and it is also possible to use a means of spraying ink from the nozzle by heating ink using a heater element. Furthermore, the printing method used by the printer (second device 50) is not necessarily limited to the inkjet method noted above, but can also be a laser method or thermal method.

2. Printing Control Process

Hereafter, we will describe a plurality of embodiments included in this mode executed using the constitution described above.

### First Embodiment

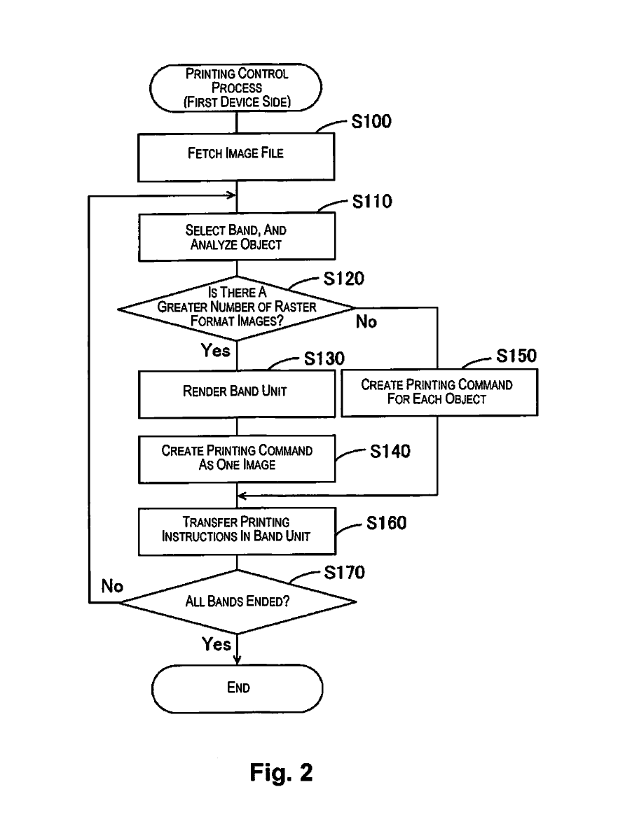

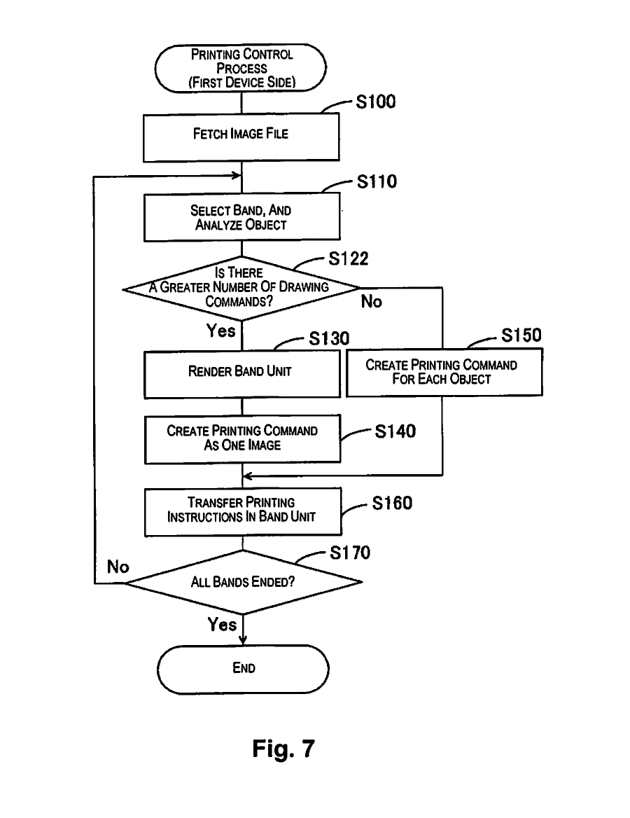

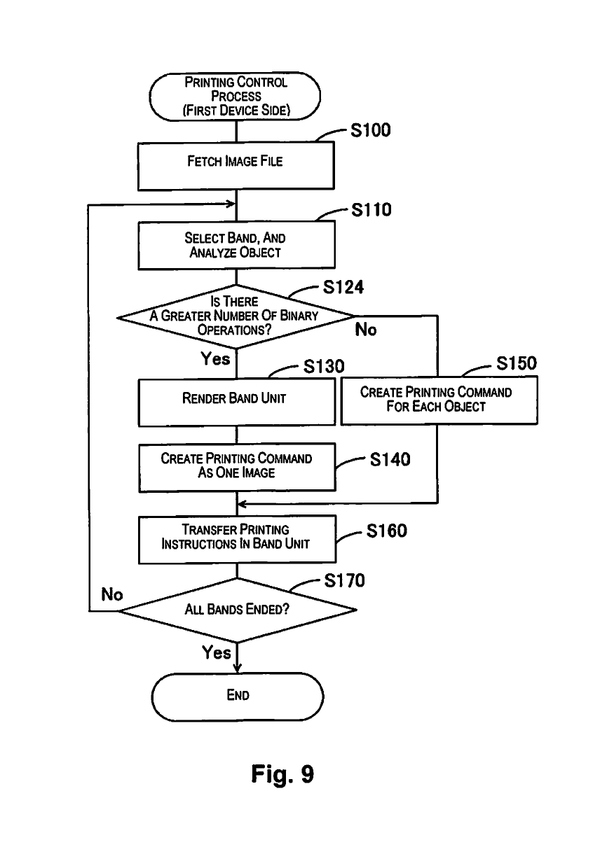

FIG. 2 is a flow chart showing the processes executed on the first device 10 side which are the printing control processes of the first embodiment. Here, we will describe this as an item for which the CPU 11 executes that flow chart using the printer driver 13 (one type of printing control program) (the same is also true for the flow charts of FIGS. 7 and 9 described later). With that flow chart being activated as a prerequisite, by the user operating the operating unit 40, we will assume a state for which any application software is activated inside the first device 10, and any files to have printed by the second device 50 are selected by the user.

Here, an image is an item that suitably expresses an original shape, color, and sense of perspective using a photograph, picture, illustration, map, characters or the like that can be seen by the human eye. Also, image data means digital data that expresses an image. As items applicable as image data, there are vector data, bit mapped images or the like. Vector data means image data saved as a set of commands and parameters expressing geometrical figures such as a straight line, circle, arc or the like. A bit mapped image is image data described by an array of pixels. Bit mapped images can also be called “raster format image data.” Pixels are the minimum element constituting an image for which color or brightness can be allocated independently.

Hereafter, we will call any file selected by the user a specified file. The user also operates the operating unit 40 and displays a UI screen for setting printing conditions on the display 30. In this state, the printer driver 13 receives selection of the printing conditions and specified image printing start instructions according to user input when a specified file is printed by the second device 50. For example, the printer driver 13 can receive various printing conditions such as printing mode (printing speed and printing resolution), type of printing substrate, printing direction, layout on the paper surface, whether it is necessary to do double sided printing and the like according to user input.

At step S100, the image fetching unit 13a fetches an image file 22 as the specified file from the application software. The image file 22 is an item generated by the application software, and for example is fetched from a designated storage area such as an HDD 20, or a memory device mounted on a connecter for external connection (not illustrated).

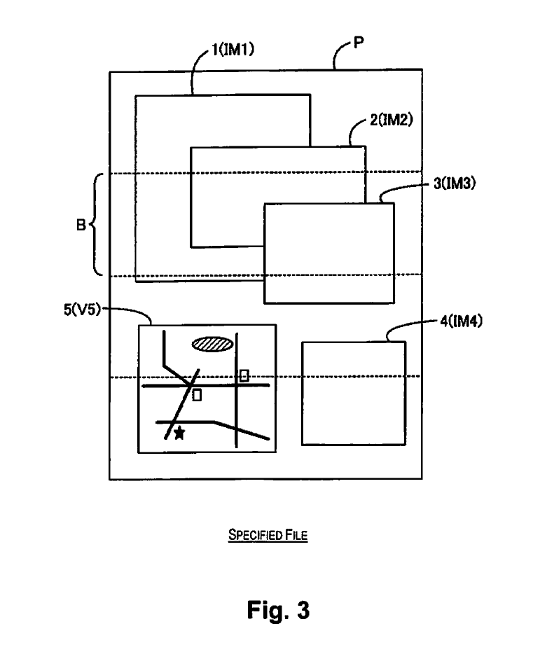

FIG. 3 is a drawing showing a typical example of a certain one page P which expresses the image file 22. The specified file has a plurality of objects inside the page P, for example. The specified file includes as objects inside the page P a photographic image 1, a photographic image 2, a photographic image 3, a photographic image 4, and a graphic image 5, for example. The objects may overlap each other. The photographic images 1, 2, 3, and 4 are photographs taken using an imaging device (digital still camera) by the user, and are expressed by respective raster format image data IM1, IM2, IM3, and IM4. The image data IM1, IM2, IM3, and IM4 are data for which a certain photographic subject is expressed in gradations with color information (e.g. red (R), green (G), blue (B)) for each pixel. Each value of R, G, and B is expressed in 256 gradations of 0 to 255, for example. The graphic image 5 is a CG (computer graphic), and is expressed with vector data V5.

At step S110, by the decision unit 13b dividing the image area of the page P of the specified file in a fixed direction, a plurality of strip shaped image areas (bands) is virtualized, and one band is selected from among the plurality of bands. The band selected at step S110 is also called the “subject band.” To make this easier to understand, in FIG. 3, an example is shown with each band demarcated by a dot-dash line. The number of bands is not particularly limited, but with the example in FIG. 3, the page P image area is divided into four bands. Also, the decision unit 13b analyzes the features of the objects contained in the subject band.

At step S120, based on the results of the aforementioned analysis regarding the object contained in the subject band, the decision unit 13b decides whether or not to expand to “band unit raster format image data.” The “band unit raster format image data” is one raster format image data that expresses one band in its entirety. With the first embodiment, when the objects contained in the subject band are expressed by raster format image data, and there is a greater number of objects than the first reference value, the decision unit 13b decides to expand the subject band to band unit raster format image data (“Yes” at step S120), and the process advances to step S130. Here, there being more objects (raster format image data) within the subject band can also express that this kind of object overlap is somewhat extensive, or that it exists.

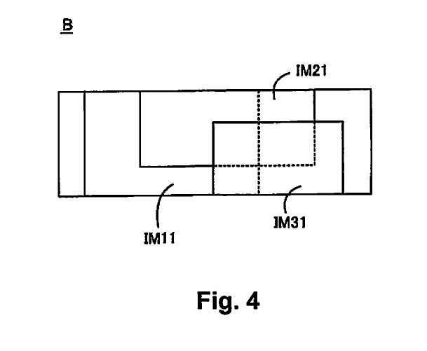

FIG. 4 shows an example of a state for which in one band B set as the subject band (see FIG. 3), a plurality of objects respectively expressed as raster format image data (image data IM11, IM21, IM31) are in an overlapping state. The image data IM11 is in a range contained in the band B of the image data IM1 shown by example in FIG. 3. Similarly, the image data IM21 is in a range contained in the band B of the image data IM2, and the image data IM31 is in a range contained in the band B of the image data IM3. As can be understood from FIGS. 3 and 4, portions of the image data IM1, IM2, and IM3 overlap with each other (IM2 (IM21) overlaps on IM1 (IM11), and furthermore, IM3 (IM31) overlaps on that). Said another way, the image data IM1, IM2, and IM3 and drawing commands arranged with image data IM1, IM2, and IM3 overlapping in this way are contained in the image file 22.

At step S120, the decision unit 13b calculates the respective pixel count of the image data IM11, IM21, and IM31 regarding band B which is the subject band, and totals those. In this case, pixels of the range in which image data overlaps of course are redundantly reckoned into the total of the number of pixels of each overlapping image data. Then, the total value of the number of pixels of image data IM11, IM21, and IM31 is compared with a preset threshold value TH1, and when that total value exceeds the threshold value TH1, a decision is made to expand the subject band to band unit raster format image data. The threshold value TH1 corresponds to an example of the first reference value. The threshold value TH1 is set to a value greater than the band size (vertical×horizontal pixel count), for example. With this setting, it is decided that for at least a portion within the band, a plurality of raster format image data are overlapping (there are enough objects for overlap to occur). The threshold value TH1 can also be a value set for comparing with the ratio of the total value of the pixel count of each raster format image data within the band in relation to the band size. In this case, when that ratio exceeds the threshold value TH1, it is decided to expand the subject band to band unit raster format image data.

Alternatively, the decision unit 13b compares the surface area ratio (ratio to the band surface area) of the range for which each raster format image data (IM11, IM21, IM31) overlaps within the band subject to decision with a preset threshold value (an example of the first reference value), and when that surface area ratio exceeds the threshold value, decides to expand the subject band to band unit raster format image data. The decision unit 13b can also simply decide to expand the subject band to band unit raster format image data when the number of raster format image data overlapping within the subject band (with the example in FIG. 4, a total of three, IM11, IM21, and IM31) exceeds a preset threshold value (example of the first reference value).

At step S130, for subject bands for which it was decided to expand to band unit raster format image data, the printing instruction generating unit 13c expands (renders) to band unit raster format image data (RGB data) according to drawing commands for drawing the object in the band.

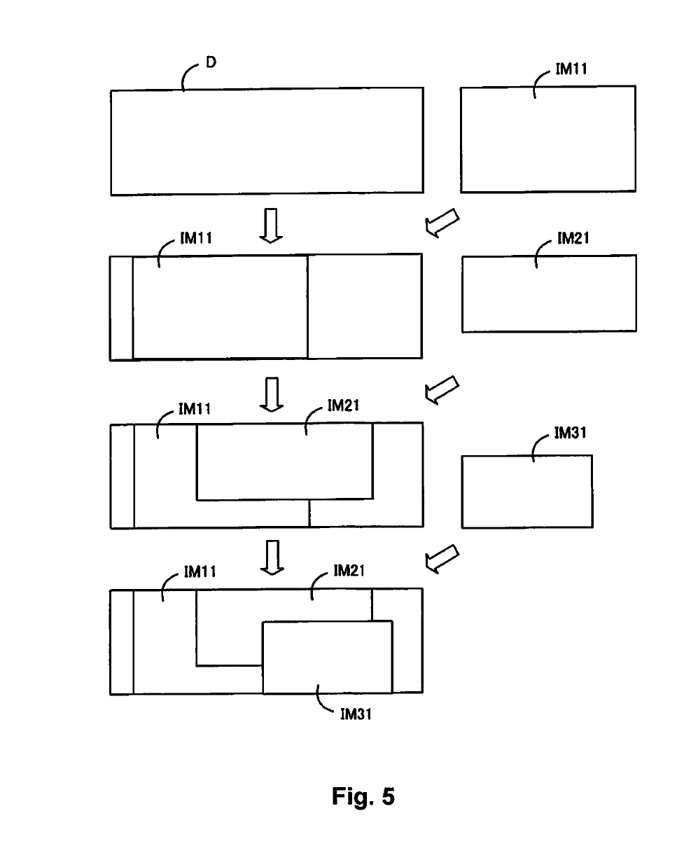

Referring to FIG. 5, we will describe the process of step S130 with an example of when the band B is the subject. In this case, the drawing commands for drawing the objects contained in the band B are the drawing commands for drawing the objects (image data IM1, IM2, IM3), and for example are the commands defining the coordinate positions for arranging the respective image data IM1, IM2, and IM3 or the overlapping method when arranging. As shown at the upper left section in FIG. 5, first, a destination D corresponding to the band size is prepared in memory. The destination D is an image area of the background (screen or printing substrate) color, and here, all pixels are white (R, G, B)=(255, 255, 255) raster format image data.

With the image file 22, copying (recording) in sequence the image data IM1, IM2, and IM3 to draw them is prescribed by the drawing commands. Therefore, the printing instruction generating unit 13c arranges (records) the image data IM11 as a source (image to be drawn) according to the coordinate position of the image data IM1 defined in the image file 22 in the destination D. Next, the printing instruction generating unit 13c arranges (records) the image data IM21 as the source according to the coordinate position of the image data IM2 defined with the image file 22 in relation to the state in which the image data IM11 is arranged, and furthermore, arranges (records) the image data IM31 as the source according to the coordinate position of the image data IM3 defined with the image file 22 in relation to the state in which the image data IM21 is arranged. The image data of the lower left section of FIG. 5 obtained in this way is one (band unit) raster format image data expressing the entire band B. When performing the process shown in FIG. 5, the printing instruction generating unit 13c can be made to extract the part correlating to the band B after the image data IM1, IM2, and IM3 are first overlapped in the sequence described above on memory, or can be made to overlap after first extracting the part contained in the band B (image data IM11, IM21, and IM31) respectively from the image data IM1, IM2, and IM3.

At step S140, the printing instruction generating unit 13c creates a printing command for having the band unit raster format image data rendered at the most recent step S130 drawn (printed) by the second device 50. The printing command created here is described in PDL format which can be interpreted by the second device 50 of the side receiving transfer, and stipulates the coordinate positions or the like at which to draw the band unit raster format image data. The printing instruction generating unit 13c can also perform compression to decrease the data volume for the band unit raster format image data rendered at the most recent step S130.

At step S160 after step S140, the transfer unit 13d transfers the band unit printing command created at the most recent step S140 together with the band unit raster format image data expanded at the most recent step S130 (if compressed, data in a compressed state) to the printing unit (second device 50) via the transfer path 70.

At step S160, the information transferred in band units to the second device 50 correlates to the band unit printing instructions. Also, information relating to the printing conditions selected by the user and the like are included in the printing instructions transferred from the first device 10 to the second device 50.

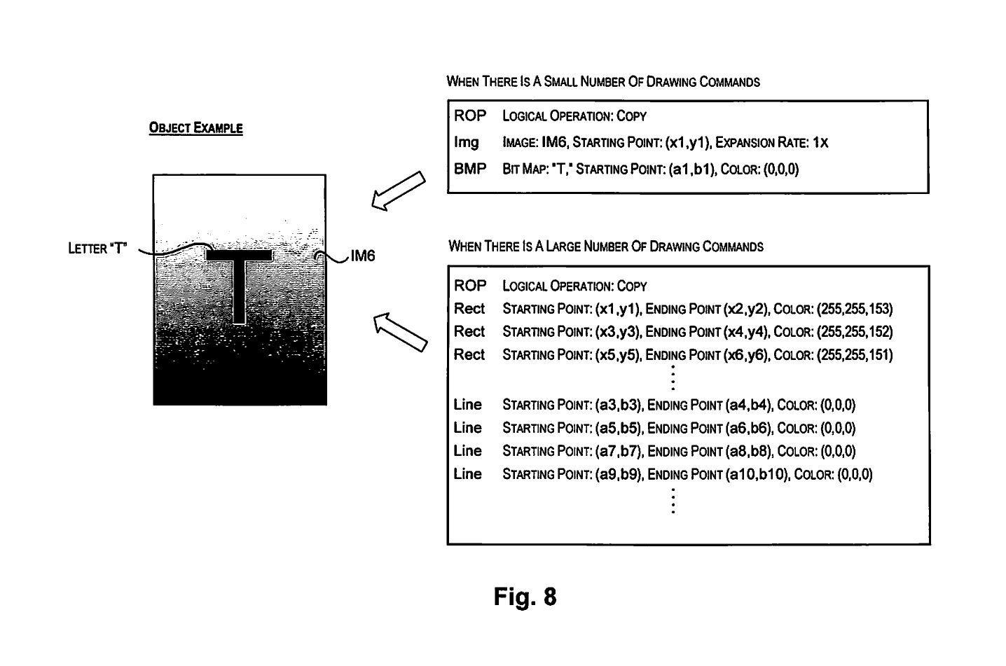

On the other hand, at step S120, when it is decided for the subject band not to expand to band unit raster format image data (“No” at step S120), the process advances to step S150. At step S150, the printing instruction generating unit 13c creates for each object a printing command for having each object contained in the subject band for which it was decided to not expand to the band unit raster format image data drawn (printed) by the second device 50. The drawing command for each object is already defined in the image file 22 (see FIG. 8 described later). Because of this, at step S150, at least a portion of the drawing commands for the object contained in the subject band of the drawing commands for each object defined in the image file 22 executes the process of converting to an instruction (printing command) in a PDL format that can be interpreted by the second device 50 of the transfer receiving side. When the object according to raster format image data is contained in the subject band, the printing instruction generating unit 13c can also perform compression to decrease the data volume for that object unit image data.

At step S160 after step S150, the transfer unit 13d transfers printing commands for each object contained in the subject band created at the most recent step S150 to the printing unit (second device 50) via the transfer path 70. Of course, when the objects contained in the subject band are raster format image data, that object unit raster format image data (if compressed, data in a compressed state) is transferred together. With step S160 after this kind of step S150, the printing command for each object contained in the subject band is transferred as PDL data consolidated in a band unit. Then, that PDL data is made to include the raster format image data (if compressed, data in a compressed state) for each object contained in the subject band. What is meant by “made to include” here is that it is also possible to express the raster format image data for each object by inserting, attaching, embedding it or the like within the PDL data. Also, “embedding” means both a case of the raster format image data itself being embedded inside the PDL data, and a case of embedding the link information (link information that allows access to that item itself) showing the position at which that item itself exists. Alternatively, it is also possible to have the aforementioned “made to include” raster format image data included in the PDL data after it has been consolidated in a band unit after converting to PDL format data.

At step S170, the decision unit 13b decides whether or not the processes of steps S110 to S160 have ended for all the bands constituting the image area of the page P. When processing has not ended for all the bands, the process returns to step S110, and a band not selected up to then is selected as the new subject band. Meanwhile, when processing for all the bands has ended, that flow chart ends.

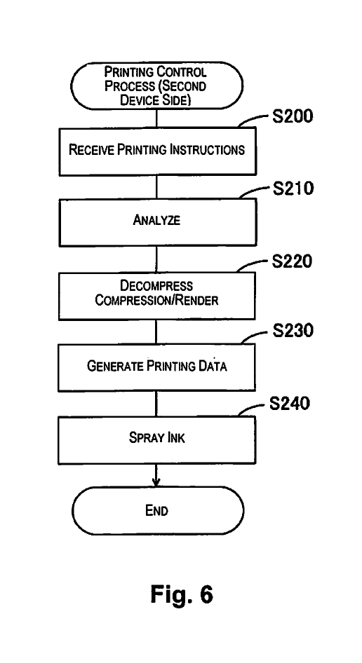

FIG. 6 is a flow chart showing the processes executed on the second device 50 side which are the printing control processes of this embodiment. Here, we will describe this as an item for which the CPU 51 executes that flow chart using firmware FW.

At step S200, the firmware FW receives printing instructions transferred in band units via the transfer path 70 from the first device 10 side. The firmware FW analyzes the received printing instructions (step S210), and for each band unit, decides whether or not that is raster format image data expanded in band units, whether or not it is compressed raster format image data or the like.

At step S220, the firmware FW executes decompression (also called expansion) of the compressed data according to the results of analysis of step S210, or rendering according to the printing command. In other words, if it is band unit printing instructions transferred via steps S130, S140 (FIG. 2), that is already raster format image data expanded in band units, so decompression is performed if decompression is required (if compressed).

Meanwhile, if there are band unit printing instructions transferred via step S150, that is not a raster format image data expanded in band units. Because of that, expansion (rendering) is done to band unit raster format image data according to the printing command of each object contained in the printing instruction. At this time, when the image data expressing the object that is subject to rendering is compressed, rendering is done after doing decompression. With the rendering executed at that step S220, this is not an area such as one for which the band has a large volume of raster format image data, so compared to rendering when executed with step S130 (FIG. 2) (e.g. rendering that involves recording of an image a plurality of times described in FIG. 5), the operation volume is low.

At step S230, the firmware FW generates printing data for printing the page expressed by the specified file based on the band unit raster format image data obtained by the processes up to step S220. At the stage that the raster format image data of all the bands of one page are fully complete, the firmware FW can be executed under step S230 with all the raster format image data of all those bands as the processing subject, or can be executed in sequence under step S230 with the band unit raster format image data each time the band unit raster format image data is fetched as the processing subject. At step S230, the firmware FW executes resolution conversion processing to match the resolution of the image data subject to processing to the printing resolution.

The firmware FW also executes color conversion processing of the image data subject to processing as necessary. In other words, it converts the color system of the image data to the ink color system used for printing by the second device 50. For example, as described above, when the image data subject to processing expresses the color information of each pixel using RGB, ink data volume is obtained by converting RGB for each pixel to gradation values for each of CMYK. The color conversion process can be executed by referencing any color conversion lookup table. Each item of CMYK can be expressed using 256 gradations, for example. Furthermore, the firmware FW implements halftone processing (half toning) on the image data after color conversion (ink volume data). There is no specific limit on the specific method of halftone processing. For example the firmware FW can execute halftone processing by dithering using a dither mask saved in advance in a designated storage area, or can also execute halftone processing using an error diffusion method. By doing the halftone process, halftones (printing data) prescribing spraying or not spraying of CMYK ink is generated for each pixel. Spraying or not spraying of ink can also be called forming or not forming of dots on the printing substrate. Dots mean ink drops in a state adhered to the printing substrate.

At step S240, the firmware FW performs the process of realigning the sequence in which to transfer the printing data generated by the process of step S230 to the printing head 57. With this realigning process, for each ink stipulated by the printing data, at which timing spraying is to be done by which nozzle 57a is set according to the pixel position and ink type. The printing data after this realignment process undergoes execution of ink spraying from each nozzle 57a by the firmware FW sending it in sequence to the ASIC 55. By doing this, the page expressed by the specified file (see FIG. 3) is reproduced on the printing substrate based on the printing data.

In this way, with this embodiment, the first device 10 does expansion to band unit raster format image data only for bands for which it is decided to expand to band unit raster format image data based on the features of the object contained in the band, and transfers the expanded image data to the second device 50. Also, for bands for which it is decided to not expand to band unit raster format image data, the drawing commands (printing command that can be interpreted by the second device 50) for drawing the objects contained in the band are transferred to the second device 50, and that expansion to the band unit raster format image data is executed on the second device 50 side. Also, branching from step S120 to step S130 or step S150 can also be called selecting whether to send one raster format image data expressing all of that area for a certain area within the page to the second device 50, or whether to send drawing commands (printing commands that can be interpreted by the second device 50) of each individual object contained in that area and the raster format image data of each of the individual objects to the second device 50. In particular, with the first embodiment, when raster format image data is contained at a certain level of volume in the band, expansion (rendering) to band unit raster format image data is done on the first device 10 side before transferring to the second device 50. Because of that, when rendering was performed on the second device 50 side that received transfer of the drawing commands (printing commands that can be interpreted by the second device 50), it is possible to avoid having rendering executed on the second device 50 side for bands anticipated to have a fairly large processing burden. As a result, there is a significant reduction in the processing burden on the second device 50 side, and printing by the second device 50 is accelerated.

In particular, in consideration of the situation that there are many cases when the second device 50 as a printer has more degradation of the operation processing capacity than the first device 10, it is very effective to realize high speed printing by decreasing the processing burden on the second device 50 side in this way. Similarly, with this embodiment, for bands for which it is anticipated the processing burden will not be very big when performing rendering on the second device 50 side, already rendered band unit raster format image data is not transferred to the second device 50, and drawing commands (printing commands that can be interpreted by the second device 50) for each object unit and raster format image data are transferred. By doing this, the volume of information transferred is reduced (shortening the transfer time), which contributes to the realization of high speed printing.

### Second Embodiment

FIG. 7 is a flow chart showing the processes executed on the first device 10 side which are the printing control processes of the second embodiment. FIG. 7 differs from FIG. 2 in that step S122 is executed instead of step S120 of FIG. 2.

At step S122, the decision unit 13b decides whether or not to expand to band unit raster format image data based on the results of analysis regarding the features of the objects contained in the subject band. In specific terms, when there is a greater number of drawing commands for drawing the objects contained in the subject band than a second reference value, the decision unit 13b decides to expand the subject band to band unit raster format image data (“Yes” at step S122), and the process advances to step S130.

FIG. 8 is an example for describing the number of drawing commands to be considered with the decision of step S122. At the left side of FIG. 8, as an example of the objects contained in the specified image, shown is a color image in gradation form, and an image consisting of the letter “T” in black recorded over that.

The drawing commands (drawing command bundle) required to draw this kind of object when the gradation form color image part and the black letter “T” of the object are expressed using raster format image data can be described as shown with “when there are few drawing commands” within FIG. 8, for example. The command “ROP” means setting the logical operation for the drawing operation (raster operation), and “Copy” as the logical operation means the commands thereafter drawn by copying (recording).

The command “Img” means drawing a raster format RGB image, and prescribes the raster format image (e.g. image data IM6) to be drawn, the drawing start point coordinates, and the expansion rate during drawing.

The command “BMP” means drawing a letter in raster format, and stipulates the drawing starting point coordinates and the letter color (R, G, B) of the letter “T” to be drawn.

Specifically, the number of drawing commands for drawing the objects shown by example in FIG. 8 using raster format image data respectively corresponding to the gradation form color image part and the letter “T” is sufficient at three, which is a very low number.

On the other hand, it is also possible to draw the objects shown by example in FIG. 8 using vector data. The drawing commands (drawing command bundle) required in this case can be described as “when there are many drawing commands” within FIG. 8, for example. The command “Rect” means drawing a rectangular as the graphic, and stipulates the drawing start point coordinates, end point coordinates, and graphic color (R, G, B). The command “Line” means drawing a line, and stipulates the drawing start point coordinates, end point coordinates, and line color (R, G, B). To draw the gradation form color image part using a collection of graphics (rectangles), a large number of commands “Rect” are needed to draw a large number of small rectangles of different colors. Also, to draw the letter “T” using a collection of lines, a large number of commands “Line” are needed to draw a large number of lines. In this way, to draw the objects shown by example in FIG. 8 using vector data, a very large number of (e.g. several hundred) drawing commands is necessary. In other words, the operation volume becomes large for rendering bands containing objects drawn using a large number of drawing commands.

What kind of drawing command is used for drawing the objects for the image file 22 depends on the application software that generated the image file 22. Because of that, the decision unit 13b totals the number of drawing commands described in the image file 22 to draw the object contained in the subject band, and when that number exceeds a preset threshold value TH2, since the number of drawing commands is large, it decides to expand the subject band to band unit raster format image data. The threshold value TH2 correlates to an example of the second reference value. For example, the objects shown in FIG. 8 are contained in the subject band, and the if the mode of the drawing command is “when there are few drawing commands” shown in FIG. 8, it decides not to expand the subject band to band unit raster format image data (advances to step S150), and if it is “when there are many drawing commands” shown in FIG. 8, decides to expand the subject band to band unit raster format image data (advances to step S130).

From step S130 and thereafter, or from step S150 and thereafter, the process is the same as for the first embodiment. Also, the process of the second device 50 side is also the same as with the first embodiment (FIG. 6).

In this way, with the second embodiment, when there is to a certain extent a large number of drawing commands for drawing the objects contained in the band, expansion (rendering) to band unit raster format image data is done in advance on the first device 10 side before transferring to the second device 50. Because of that, it is possible to avoid executing rendering on the second device 50 side for bands anticipated to have quite a large operation volume (bands containing objects expressed by a large number of drawing commands such as “when there are many drawing commands” in FIG. 8) when performing rendering on the second device 50 side that received the transfer of the drawing commands (printing commands that can be interpreted by the second device 50). As a result, it is possible to significantly reduce the processing burden on the second device 50 side, and to accelerate printing by the second device 50. Of course, with the second embodiment as well, the same effects as those of the first embodiment are exhibited based on the same constitutions as those of the first embodiment.

### Third Embodiment

FIG. 9 is a flow chart showing the process executed on the first device 10 side that is the printing control process of the third embodiment. FIG. 9 differs from FIG. 2 and FIG. 7 in that instead of steps S120 and S122 of FIG. 2 and FIG. 7, step S124 is executed.

With step S124, the decision unit 13b decides whether or not to expand to band unit raster format image data based on the results of analysis regarding the features of the objects contained in the subject band. In specific terms, the decision unit 13b decides to expand the subject band to band unit raster format image data when the number of times of the logical operation using a binary operation set with the drawing command for drawing for the objects contained in the subject band is greater than the third reference value (“Yes” at step S124), and the process advances to step S130.

As the logical operation for the raster operation, in addition to “Copy” described above, examples include “AND,” “OR,” “NOT,” “XOR (exclusive OR)” and the like. Then, of the logical operations, an operation for which one output is obtained from two inputs is called a binary operation. As the binary operation, examples include AND, OR, XOR and the like. Binary operations can be said to be operations with a greater burden than simple processes of Copy (record) or NOT.

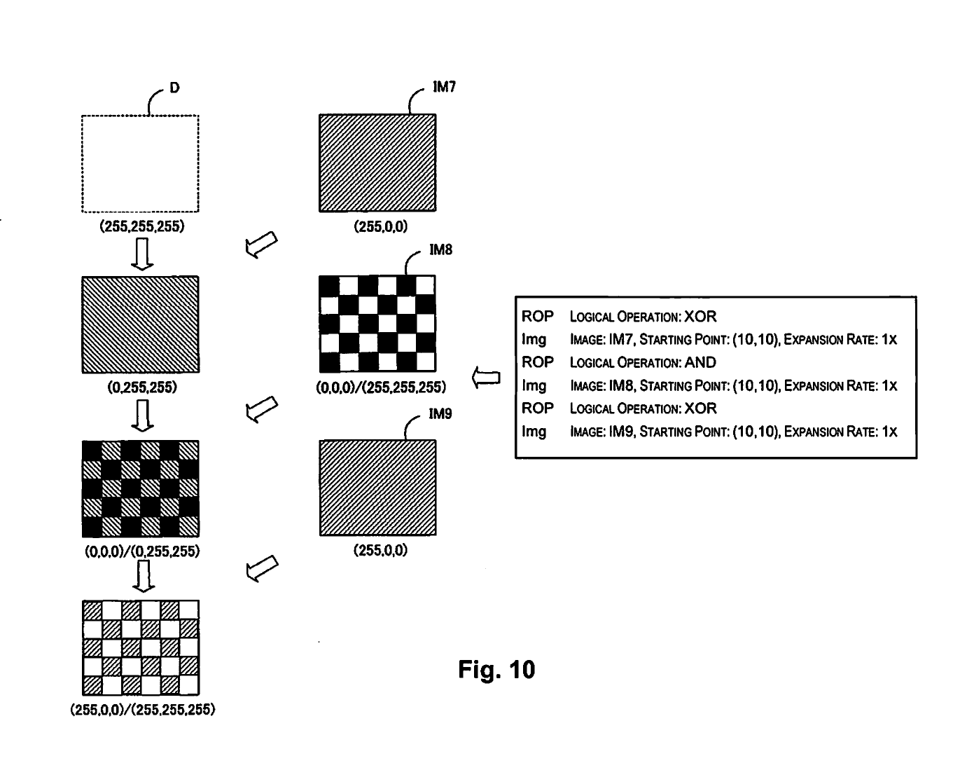

FIG. 10 shows an example of the state of a certain object being drawn as a result of repeating a binary operation. Here, an item for which an image (raster format image data IM7) of a certain color (e.g. red, (R, G, B)=(255, 0, 0)) has undergone transmission processing is assumed to be the object. At the lower left of FIG. 10, such an object is shown as an example, and at the right side of FIG. 10, drawing commands (drawing command bundle) for ultimately obtaining this object are shown as an example. As shown in FIG. 10, first, an XOR (exclusive OR) of a portion of the destination D (255, 255, 255) and the image data IM7 (255, 0, 0) are fetched. Next, an AND of the currently fetched image (0, 255, 255) and an image expressing a pattern for transmission processing (raster format image data IM8) is fetched. The pattern for transmission processing is a 50% transmission rate pattern for which a black (0, 0, 0) area and a white (255, 255, 255) area are arranged alternately to each other vertically and horizontally, for example.

Next, the object shown at the lower left in FIG. 10 is ultimately obtained using an XOR (exclusive OR) of the currently fetched image (image for which a black (0, 0, 0) area and a designated color (0, 255, 255) area are arranged alternately to each other vertically and horizontally) and the image data IM9 (255, 0, 0). Here, IM7 and IM9 are the same data. This kind of object is an item drawn by executing a binary operation a plurality of times for all the pixels constituting the object, so the operation volume is high for rendering a band containing this kind of object.

In light of that, the decision unit 13b totals the number of times of the binary operation set with the drawing command described with image file 22 for drawing the objects contained in the subject band, and when that number exceeds a preset threshold value TH3, the number of binary operations is considered to be high, and it is decided to expand the subject band to band unit raster format image data. The threshold TH3 correlates to an example of a third reference value. For example, if we assume that the object shown in FIG. 10 is contained in the subject band, the number of times of the binary operation is the object pixel count×3 times (XOR and AND and XOR). Alternatively, more simply, the decision unit 13b can compare the pixel count subject to the binary operation (object pixel count) with a designated threshold value regarded as the number of times of the binary operation (example of the third reference value), or can compare the number of times of the binary operation ignoring the pixel count (3 times with the example noted above) with a designated threshold value (example of the third reference value) to decide whether or not the number of times of the binary operation is high. Alternatively, the decision unit 13b can also immediately decide that the number of times of the binary operation is high (is not 0) when there is an object for which the binary operation is executed even one time when drawing.

The process from step S130 and thereafter or from step S150 and thereafter is the same as with the first and second embodiments. The processing of the second device 50 side is also the same as that of the first and second embodiments (FIG. 6).

In this way, with the third embodiment, when the number of binary operations with the drawing command for drawing the object contained in the band is high to a certain extent, expansion to band unit raster format image data (rendering) is done on the first device 10 side before transferring to the second device 50. Because of that, it is possible to avoid executing rendering on the second device 50 side for bands for which a significantly high operation volume is anticipated (bands containing objects expressed by repeating the kind of binary operation shown by example in FIG. 10) when rendering is performed on the second device 50 side that received transfer of the drawing commands (printing commands that can be interpreted by the second device 50). As a result, the processing burden on the second device 50 side is significantly reduced, and printing by the second device 50 is accelerated. Of course, with the third embodiment as well, the same effects as those of the first embodiment are exhibited based on the same constitutions as those of the first embodiment.

### 3. Modification Examples

The present invention is not limited to the embodiments described above, and it can be implemented in various modes in a scope that does not stray from its gist, and suitably combined contents of each of the embodiments noted above are also within the disclosed scope of the present invention.

For example, the decision unit 13b can also execute two or more types of decision among the decisions of steps S120 (FIG. 2), S122 (FIG. 7), and S124 (FIG. 9) described above, and when any one or more of the decisions is “Yes,” can advance to step S130. In other words, it is possible to decide comprehensively whether or not a band has a certain high level of processing volume during rendering according to a plurality of differing decision criteria.

The printing control processes of FIG. 2, FIG. 7, and FIG. 9 (are a combination thereof) can also be performed within the printer (second device 50). For example, in addition to the CPU 51 realizing each of the functions described above of the image fetching unit 13a, the decision unit 13b, the printing instruction generating unit 13c, and the transfer unit 13d, another control unit can also execute the processes of FIG. 6 based on the information transferred by that transfer unit 13d to the other control unit within the printer. In this case, the CPU 51 receives operations for the printing conditions or printing instructions for the specified image from the user via the operating panel 59 or an external portable terminal that can communicate with the second device 50 or the like. Alternatively, the flow charts of FIG. 2, FIG. 7, and FIG. 9 (or a combination thereof) can also be realized divided between the printer driver 13 and the firmware FW.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a selected embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents.

What is claimed is:

1. A printing control device comprising:
an image fetching unit configured to fetch image files expressing a page containing objects;
a decision unit configured to divide the page into a plurality of bands, and configured to, for each band, decide whether or not to expand to band unit raster format image data based on features of the objects contained in the band;
an image expansion unit configured to, for a band for which it is decided to expand to the band unit raster format image data, expand to the band unit raster format image data according to drawing command for drawing the objects contained in the band; and
a transfer unit configured to, for a band that has been expanded to the band unit raster format image data, transfer the expanded band unit image data to a printing unit, and configured to, for a band that has not been expanded to the band unit raster format image data, transfer drawing command for drawing the objects contained in the band to the printing unit.

2. The printing control device according to claim 1, wherein
at least when the objects contained in the band subject to decision are expressed as raster format image data and are more than a first reference value, the decision unit is further configured to decide to expand the band subject to decision to the band unit raster format image data.

3. The printing control device according to claim 1, wherein
at least when the drawing command for drawing the objects contained in the band subject to decision is more than a second reference value, the decision unit is further configured to decide to expand the band subject to decision to the band unit raster format image data.

4. The printing control device according to claim 1, wherein
at least when the number of times of logical operation according to a binary operation set with the drawing command for drawing the objects contained in the band subject to decision is greater than a third reference value, the decision unit is further configured to decide to expand the band subject to decision to the band unit raster format image data.

5. A printing control method comprising:
fetching image files for expressing a page containing objects;
dividing the page into a plurality of bands, and for each band, deciding whether or not to expand to band unit raster format image data based on features of the objects contained in the band;
for a band for which it is decided to expand to the band unit raster format image data, expanding to the band unit raster format image data according to drawing command for drawing the objects contained in the band; and
for a band that has been expanded to the band unit raster format image data, transferring the expanded band unit image data to a printing unit, and for a band that has not been expanded to the band unit raster format image data, transferring drawing command for drawing the objects contained in the band to the printing unit.

6. A non-transitory computer readable medium having stored thereon a printing control program, which is realized by a computer executing functions of printing control comprising:
fetching image files for expressing a page containing objects;
dividing the page into a plurality of bands, and for each band, deciding whether or not to expand to band unit raster format image data based on features of the objects contained in the band;
for a band for which it is decided to expand to the band unit raster format image data, expanding to the band unit raster format image data according to drawing command for drawing the objects contained in the band; and
for a band that has been expanded to the band unit raster format image data, transferring the expanded band unit image data to a printing unit, and for a band that has not been expanded to the band unit raster format image data, transferring drawing command for drawing the objects contained in the band to the printing unit.
